(19) United States
(12) Patent Application Publication
(10) Pub. No.: US 2015/0284533 A1
(43) Pub. Date: Oct. 8, 2015

(54) PROCESS FOR IMPROVING AGENT COMPOSITION

(71) Applicant: Nanotech Ceramics Co., Ltd., Busan City (KR)

(72) Inventor: Sang-Ok Jeong, Busan-si (KR)

(21) Appl. No.: 14/303,914

(22) Filed: Jun. 13, 2014

(30) Foreign Application Priority Data
Apr. 7, 2014 (KR) 10-2014-0041414

(51) Int. Cl. C08K 5/098; C08K 3/26; C10M 125/10; C08K 3/36; C10M 105/24; C10M 125/26

(52) U.S. Cl. CPC C08K 5/098; C10M 105/24; C10M 125/26; C10M 125/10; C08K 3/36; C08K 3/26; C08K 2003/267; C10M 2201/105; C10M 2201/062; C10M 2207/126

(57) ABSTRACT

Embodiments of the present invention provide an agent composition for improving the machinability of a polymer modifier. Specifically, among other things, embodiments of the present invention provide an agent composition which includes a lubricant and ceramic. In one example, 5 to 50 parts by weight of lubricant and 10 to 50 parts by weight of ceramic may be used with respect to 100 parts by weight of polymer modifier.

### CROSS-REFERENCE TO RELATED APPLICATION

This application claims priority under 35 U.S.C §119 to Korean Patent Application No. 10-2014-0041414, filed on Apr. 7, 2014, in the Korean Intellectual Property Office, the contents of which are incorporated herein by reference.

### BACKGROUND OF THE INVENTION

1. Field of the Invention

Conventionally, a polymer modifier is used as an adhesion, compatibilizer, or coupling agent. When it is used as an addition agent or a base in a blend, it tends to be too highly adhesive to the metal surface of a processing apparatus being used (e.g., kneader, mixing roll), which leads to difficulty in carrying out successive work operations. Therefore, a need exists in the art for providing an agent composition that is added to increase machinability of a polymer modifier by improving its adhesive property.

2. Description of the Related Art

Patent Documents 1 and 3 (referred to herein) attempt to resolve the issues above by reducing the frictional resistance of the processing apparatus against the metal surface by using lubricants. However, in cases when the surface of the processing apparatus is abrased, the use of a lubricant is not helpful because adhesion will still exist on the metal surface, and, when successive work operations are carried out, the increased adhesion area results in reduced workability and workman safety issues.

Also, doubling or tripling the amount of lubricant used may improve adhesion reduction but may cause problems such as surface bleeding and blooming. It may also be problematic in successive work operations such as coating, adhesion, lamination, and printing.

A method exists to control the processing temperature by controlling the polymer modifier's melting temperature. However, applying this method during operation increases the mulling time to disperse the polymer modifier, which may lead to reduced productivity and/or polymer modifier malfunction due to inappropriate dispersion.

Conventionally, during an operation to manufacture a compound with a fusion mixture, the temperature of a processing apparatus must be 10 to 20 degrees Celsius higher than that of the melting temperature of the polymer modifier to maintain productivity. Therefore, it is difficult to maintain that processing temperature precisely. Since the frictional heat generated through the fusion mixture needs to be controlled with a coolant, this gives rise to a subsidiary process and additional costs making it an unattractive way to control the processing temperature.

### RELATED ART

Patent Document 1: Korea Public Patent Document No. 10-2007-0097743 entitled “Composition of Olefin thermoplastic resin with excellent calendar finishability”.

Patent Document 2: Korea Public Patent Document No. 10-2006-0045130 entitled “Ethylene copolymer, a composition of the ethylene copolymers, a formed articles and manufacturing method of a formed articles composition”.

Patent Document 3: Korea Public Patent Document No. 10-2013-0052569 entitled “Foaming body manufacturing ethylene-a-olefin copolymer, foaming body manufacturing resin composition as well as foaming body manufacturing method”.

### SUMMARY OF THE INVENTION

In general, embodiments of the present invention provide an agent composition for improving the machinability of a polymer modifier. Specifically, among other things, embodiments of the present invention provide an agent composition which includes a lubricant and ceramic. In one example, 5 to 50 parts by weight of lubricant and 10 to 50 parts by weight of ceramic may be used with respect to 100 parts by weight of polymer modifier.

A first aspect of the present invention provides an agent composition for improving the machinability of a polymer modifier, comprising: a lubricant; and a ceramic.

A second aspect of the present invention provides a method producing an agent composition for improving the machinability of a polymer modifier, comprising compounding a lubricant and a ceramic.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an actual view of a kneader machinability comparison when processing a polymer base according to an embodiment of the present invention.

FIG. 2 depicts an actual view of a mixing roll machinability comparison when processing a polymer base according to an embodiment of the present invention.

FIG. 3 depicts a scanning electron microscopy (SEM) view according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As mentioned above, embodiments of the present invention provide an agent composition for improving the machinability of a polymer modifier. Specifically, among other things, embodiments of the present invention provide an agent composition which includes a lubricant and ceramic. In one example, 5 to 50 parts by weight of lubricant and 10 to 50 parts by weight of ceramic may be used with respect to 100 parts by weight of polymer modifier.

The agent composition may be used to resolve the issues addressed above. As an addition agent or base, the composition is highly adhesive to metal surfaces compared to existing technology where lubricant is used exclusively. The composition minimizes the adhesive area due to anti-blocking on the compound surface, which in turn improves the adhesion of the processing apparatus on the metal surface with an equal or lesser amount of lubricant. The composition enables successive operational work without controlling the processing temperature while keeping the existing process. This increases not only compound manufacturing productivity but also the function and performance of the polymer modifier. In another example, a composition including a lubricant and ceramic may be used with a polymer modifier with the same effect.

The present invention relates to improving an agent composition to deliver the stated effectiveness. Only portions necessary to understand the technical composition of such invention are explained. It may be noted that other portions are intentionally omitted in order not to distract from the substance of the invention. The following explains, in detail, a process for improving the agent composition according to the invention illustration.

The agent composition is used to improve the machinability of the polymer modifier. As such, the agent composition may include a combination of lubricant and ceramic. Specifically, 5 to 50 parts by weight of lubricant and 10 to 50 parts by weight of ceramic may be used with respect to 100 parts by weight of polymer modifier.

The polymer modifier can take on various polymer types. For example, the polymer modifier may include polypropylene, polyethylene, ethylene-vinylacetate copolymer, ethylene-octane copolymer, ethylene-butene copolymer, or ethylene-acrylate copolymer. Thermoplastic polyurethan, polyamide, and polyether-block amide may be compounded as a base or addition agent. In addition, maleic anhydride grafted polyolefins, ethylene-acid copolymer, acid or anhydride modified polymer, ionomer that neutralizes ethylene-acid copolymer with metallic acid, ethylene-vinylacetate-maleic anhydride terpolymer, or ethylene-acrylic ester-maleic anhydride terpolymer can be applied. The types above are exemplary only and not intended to be limiting. Other types of conventionally used high-molecule modifiers may also be used. Per one hundred parts by weight of polymer base, 2.5 to 30 parts by weight of polymer modifier may be used.

A lubricant is designed to reduce frictional resistance with metal and can be adjusted based on the content of the polymer modifier, as well as the degree of modification needed, rather than based on the weight of the polymer base.

Considering this, per hundred parts by weight of polymer modifier, 5 to 50 parts by weight of lubricant may be used and joined with ceramic. If the lubricant content is below 5, it fails to lower the frictional resistance which, in turn, fails to improve machinability and is prone to adhesion issues in successive operations. If the lubricant content is greater than 50, the adhesion improvement is nullified which causes blooming and bleeding on the compound's surface. This becomes problematic in successive operations such as coating, adhesion, laminating, and printing.

The lubricant may be selected from stearine metallic salts, fatty acids, alcohol, ester, glyceryl stearate or sorbitan stearate. The stearine metallic salts may include stearine zinc, stearine magnesium, stearine calcium, stearine barium, stearine calcium, stearine natrium, or stearine aluminum. The fatty acids may include halocarbon wax, stearate, or olein. The alcohol may include fatty acid amide, diethylene glycol, ethylene glycol, glycerin, or polytetramethylene glycol. The ester may include low-grade fatty acidic alcohol ester, fatty acidic alcohol ester, or fatty acidic polyglycol ester.

Ceramic is used to reduce the contact surface area due to anti-blocking. It is highly porous and high in specific surface area, making it an effective compound to use. Specific surface area describes the surface area per unit mass with units of square meters per gram (m2/g). Related to ceramic usage, the specific surface area may be over 10 m2/g. The specific surface area can be adjusted based on the polymer modifier's content and degree of modification, rather than the weight of the polymer base. Per one hundred parts by weight of polymer modifier, 10 to 50 parts by weight of ceramic may be used with a lubricant.

If ceramic content is less than 10 parts by weight, the anti-blocking effect is low which fails to improve machinability, and it becomes prone to adhesive issues during successive operations. If the ceramic content is over 50 parts by weight, the increased weight takes away the adhesive improvement effect and causes the manufactured compound's density to increase and the mechanical strength to be greatly reduced.

The ceramic content may be selected from wet process silica, dry process silica, magnesium carbonate, high-porosity soft coal, nano-sized calcium carbonate, clay, talc, glass fiber, kaolin, wollastonite, or mica.

The process includes the joint use of lubricant and ceramic for improving agent composition. In one example, the ceramic may be surface coat-processed with the lubricant. In another example, the ceramic may be surface coat-processed with the lubricant, and the polymer modifier or commercial polymer (e.g., the aforementioned polymer base) can be jointly applied in a master-batch form.

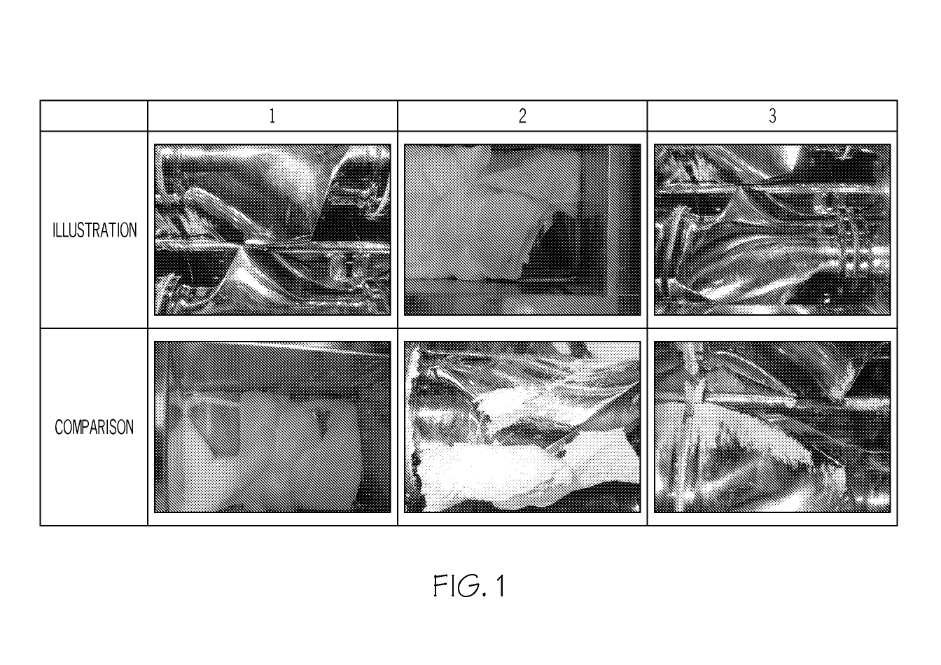

The present invention is described in more detail below with reference to FIGS. 1-3. The illustrations are illustrative only and not intended to be limiting.

FIG. 1 depicts an actual view of a kneader machinability comparison when processing a polymer base according to an embodiment of the present invention. In Illustrations 1-3, ethylene vinyl acetate copolymer (22 percent by weight of vinyl acetate content) is used as the polymer base. Per one hundred parts by weight of such polymer, 3 parts by weight of basic addition agent zinc oxide, 3 parts by weight of titanium dioxide, 15 parts by weight of polyethylene grafted by a polymer modifier called maleic anhydride, 2.5 parts by weight of wet process silica (i.e., the ceramic), and 1.5 parts by weight of lubricant zinc stearate are added and mixed in a kneader at 90 to 100 degrees Celsius (° C.) for approximately 10 minutes and, subsequently, evenly dispersed in a mixing roll mill whose surface temperature is approximately 100° C. to process.

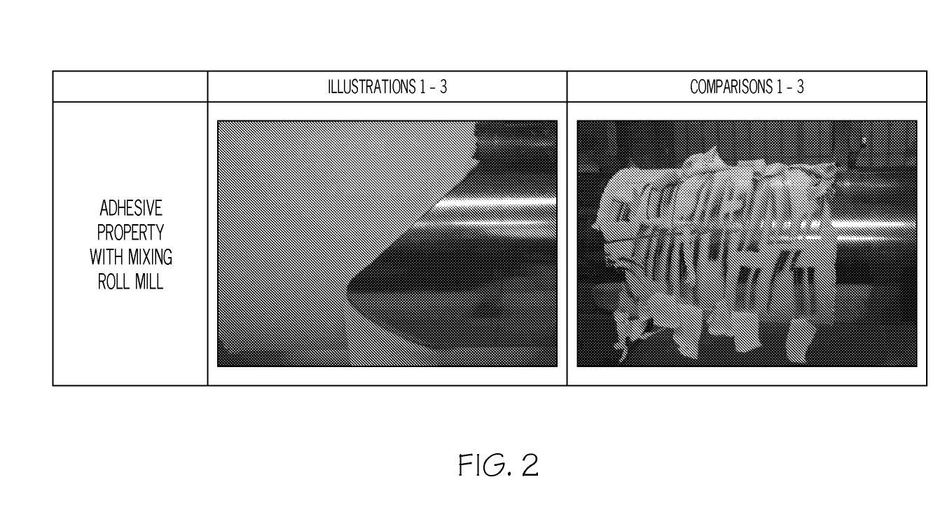

FIG. 2 depicts an actual view of a mixing roll machinability comparison when processing a polymer base according to an embodiment of the present invention. In Illustrations 1-3, low-density polyethylene (MI=3 g/10 serving) is used as the polymer base. Per one hundred parts by weight of such polymer, 3 parts by weight of zinc oxide (i.e., an addition agent), 3 parts by weight of titanium dioxide, 15 parts by weight of polymer modifier ethylene-acid copolymer, 5 parts by weight of ceramic magnesium carbonate, and 2 parts by weight of lubricant polyethylene glycol are mixed in a kneader at 110 to 120° C. and, subsequently, evenly dispersed in a mixing roll mill whose surface temperature is approximately 110 to 120° C. to process.

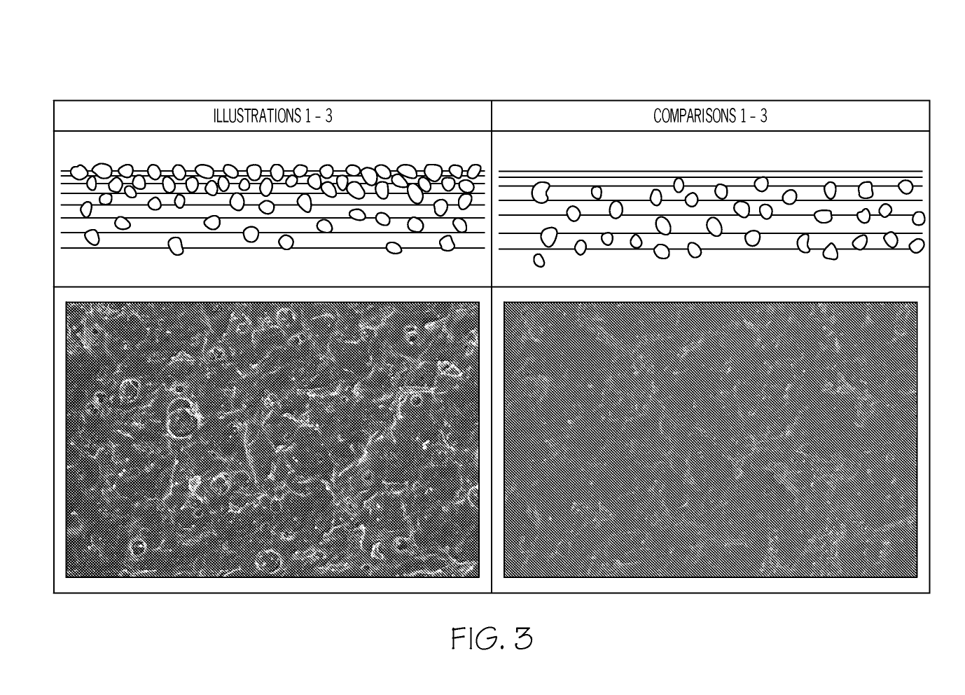

FIG. 3 depicts a scanning electron microscopy (SEM) view according to an embodiment of the present invention. In Illustrations 1-3, a polymer base of ethylene vinyl acetate copolymer (22 percent by weight of vinyl acetate content) and low-density polyethylene (MI=3 g/10 serving) are mixed in a ratio of 70:30. Per one hundred parts by weight of such polymer, 3 parts by weight of zinc oxide (i.e., basic addition agent), 3 parts by weight of titanium dioxide, 15 parts by weight of polyethylene grafted by polymer modifier maleic anhydride, 3 parts by weight of wet process silica (i.e., ceramic), 1.5 parts by weight of lubricant zinc stearate, and 1.5 parts by weight of polyethylene glycol are added and mixed in a kneader at 120 to 125° C. for approximately 10 minutes and subsequently in a mixing roll mill at a surface temperature of approximately 110-120° C., where the polymer base is evenly dispersed.

With respect to comparison example 1, ethylene vinyl acetate copolymer (22% by weight of vinyl acetate content) is used as a polymer base. Per one hundred parts by weight of the polymer base, 3 parts by weight of basic addition agent zinc oxide, 3 parts by weight of titanium dioxide, 15 parts by weight of polyethylene grafted by polymer modifier maleic anhydride, and 1.5 parts by weight of lubricant zinc stearate are added and mixed in a kneader for approximately 10 minutes and subsequently in a mixing roll mill with a surface temperature of approximately 100° C., where the polymer base is evenly dispersed.

With respect to comparison example 2, low-density polyethylene (MI=3 g/10 minutes) is used as a polymer base. Per one hundred parts by weight of the polymer base, 3 parts by weight of basic addition agent zinc oxide, 3 parts by weight of titanium dioxide, 15 parts by weight of high-molecule ethylene-acid copolymer, and 4 parts by weight of lubricant polyethylene glycol 4 are added in a kneader at 110-120° C. for approximately 10 minutes and subsequently in a mixing roll mill with a surface temperature of approximately 110-120° C., where the polymer base is evenly dispersed.

With respect to comparison example 3, ethylene vinyl acetate copolymer (22% per weight of vinyl acetate content) and low-density polyethylene (MI=3 g/10 serving) are mixed in a ratio of 70:30 to form a polymer base. With respect to 100 parts by weight of the polymer base, 3 parts by weight of basic addition agent zinc oxide, 3 parts by weight of titanium dioxide, 15 parts by weight of polyethylene grafted by polymer modifier maleic anhydride, 2 parts by weight of lubricant zinc stearate, 2 parts by weight of polyethylene glycol, and 2 parts by weight of stearic acid are added and mixed in a kneader at 120-125° C. for approximately 10 minutes and subsequently in a mixing roll mill with a surface temperature at approximately 110-120° C., where the polymer base is evenly dispersed.

The mixing ratios of Illustrations 1-3 and Comparisons 1-3 are summarized in the table below.

TABLE 1

| | Illustration | | | Comparison | | |
|---|---|---|---|---|---|---|
| Classification | 1 | 2 | 3 | 1 | 2 | 3 |
| Ethylene Vinyl Acetate | 100 | — | 70 | 100 | — | 70 |
| Copolymer | | | | | | |
| Polyethylene | — | 100 | 30 | — | 100 | 30 |
| Zinc Oxide | 3 | 3 | 3 | 3 | 3 | 3 |
| Titanium Oxide | 3 | 3 | 3 | 3 | 3 | 3 |
| Polymer Modifier | 15 | — | 15 | 15 | — | 15 |
| Polymer Modifier | — | 15 | — | — | 15 | — |
| Wet Process Silica | 2.5 | — | 3 | — | — | — |
| (Ceramic) | | | | | | |
| Magnesium Carbonate | — | 5 | — | — | — | — |
| (Ceramic) | | | | | | |
| Stearine Zinc (Lubricant) | 1.5 | — | 1.5 | 1.5 | — | 2 |
| Lubricant | — | 2 | 1.5 | — | 4 | 2 |
| Stearic Acid | — | — | — | — | — | 2 |

The machinability results of Illustrations 1-3 and Comparisons 1-3 are summarized in the table below.

TABLE 2

| | Illustration | | | Comparison | | |
|---|---|---|---|---|---|---|
| Classification | 1 | 2 | 3 | 1 | 2 | 3 |
| Kneader | Good | Excellent | Excellent | Terrible | Bad | Average |
| Machinability | | | | | | |
| Mixing Roll | Good | Excellent | Excellent | Terrible | Ter- | Terrible |
| Machinability | | | | | rible | |
| Successive | Good | Excellent | Excellent | Terrible | Bad | Bad |
| Usability | | | | | | |

As illustrated in Table 1 and FIG. 1, where a ceramic and lubricant is jointly used, the compound was found not to adhere to the surface of the apparatus. In the comparison example where only a lubricant is used, the compound remained to be adhered on the surface. Particularly, in comparison 3, per hundred parts by weight of a polymer modifier, even the usage of 40 parts by weight of lubricant resulted in a compound adhering to a kneader's surface, which is problematic to carry out successive operations swiftly.

Moreover, as illustrated in Table 2 and FIG. 2, where a ceramic and lubricant are jointly used, the compound was not found to adhere to the surface of the apparatus. In the comparison example where only a lubricant is used resulted in a compound adhering to the surface of a mixing roll, which is problematic in carrying out successive mixing processes.

In addition, as illustrated in Table 2 and FIG. 3, where the ceramic being used has a large specific surface area which is large or is porous, the contact area deducted with the compound surface is reduced because of an anti-blocking effect. In the comparison example where a lubricant and basic addition agent are used, the inside compound is blocked and therefore cannot be deducted, which leads to no reduction in the contact area with the processing apparatus. Therefore, any successive mixing processes are made difficult to implement.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. An agent composition for improving the machinability of a polymer modifier, comprising:
a lubricant; and
a ceramic.

2. The agent composition of claim 1, in which the lubricant is 5 to 50 parts by weight to 100 parts by weight of the polymer modifier.

3. The agent composition of claim 1, in which the ceramic is 10 to 50 parts by weight to 100 parts by weight of the ceramic.

4. The agent composition of claim 1, wherein the specific surface area of the ceramic is within the range of 10 to 800 m2/g.

5. The agent composition of claim 1, wherein the ceramic includes at least one of wet process silica, dry process silica, magnesium carbonate, highly porous soft coal, nano-sized calcium carbonate, clay, talc, glass fiber, kaolin, wollastonite, or mica.

6. The agent composition of claim 1, wherein the lubricant includes at least one of stearate metallic salts, hydrocarbon wax class, fatty acid class, alcohol class, ester class, glyceril stearate, or sorbitan stearate.

7. The agent composition of claim 1, wherein a surface of the ceramic is coated with the lubricant.

8. The agent composition of claim 7, wherein the lubricant and ceramic are composed with at least one of a polymer modifier or commercial polymer to form a master batch.

9. A method for producing an agent composition for improving the machinability of a polymer modifier, comprising compounding a lubricant and a ceramic.

10. The method of claim 9, in which the lubricant is 5 to 50 parts by weight to 100 parts by weight of the polymer modifier.

11. The method of claim 9, in which the ceramic is 10 to 50 parts by weight to 100 parts by weight of the ceramic.

12. The method of claim 9, wherein the specific surface area of the ceramic is within the range of 10 to 800 m2/g.

13. The method of claim 9, wherein the ceramic includes at least one of wet process silica, dry process silica, magnesium carbonate, highly porous soft coal, nano-sized calcium carbonate, clay, talc, glass fiber, kaolin, wollastonite, or mica.

14. The method of claim 9, wherein the lubricant includes at least one of stearate metallic salts, hydrocarbon wax class, fatty acid class, alcohol class, ester class, glyceril stearate, or sorbitan stearate.

15. The method of claim 9, wherein a surface of the ceramic is coated with the lubricant.

16. The method of claim 15, wherein the lubricant and ceramic are composed with at least one of a polymer modifier or commercial polymer to form a master batch.
